(19) United States
(12) Patent Application Publication
(10) Pub. No.: US 2026/0326375 A1
(43) Pub. Date: Oct. 22, 2026

(54) Integrated Material Handling System for Fused Granular Fabrication

(71) Applicants: Connor McLeod, Madison, AL (US); Leonel Herrera, Huntsville, AL (US); David Iwami Malott, Toney, AL (US); Caela Gomes, Hoboken, NJ (US)

(72) Inventors: Connor McLeod, Madison, AL (US); Leonel Herrera, Huntsville, AL (US); David Iwami Malott, Toney, AL (US); Caela Gomes, Hoboken, NJ (US)

(73) Assignee: SpaceFactory Inc., Tanner, AL (US)

(21) Appl. No.: 19/186,510

(22) Filed: Apr. 22, 2025

(51) Int. Cl. B29C 64/329; B29C 64/106; B29C 64/255; B29C 64/336; B29C 64/343; B33Y 30/00; B33Y 40/00

(52) U.S. Cl. CPC B29C 64/329; B29C 64/106; B29C 64/255; B29C 64/336; B29C 64/343; B33Y 30/00; B33Y 40/00

(57) ABSTRACT

The present invention addresses the challenge of efficiently handling pelletized materials in large-format additive manufacturing (LFAM) systems utilizing Fused Granular Fabrication (FGF) technology. Unlike conventional FGF systems that rely on external vacuum systems, this integrated material handling system is engineered to transport pelletized materials from storage to extrusion with precision, efficiency, and minimal footprint. At the core of its compact design is the integration of a metered dispenser and onboard vacuum system synchronized with extruder throughput to deliver pellets just-in-time. This synchronization enables downsizing of all components, reducing the system's physical and energy footprint. The result is an efficient and adaptable platform capable of supporting a wide range of current and future FGF applications, including multi-material printing, automated changeover, and networked production in LFAM printer farms.

### CROSS-REFERENCE TO RELATED APPLICATIONS

This application claims the benefit of U.S. Provisional Patent Application No. 63/636,884, filed 22 Apr. 2024, entitled “Integrated Material Handling System for Fused Granular Fabrication,” the entire disclosure of which is incorporated herein by reference.

### FIELD OF THE INVENTION

This invention pertains to the field of additive manufacturing, specifically to systems and methods for handling materials in large format additive manufacturing (LFAM) environments. More particularly, the invention relates to a novel system for managing the storage, conveyance, and precise delivery of pelletized materials used in Fused Granular Fabrication (FGF) processes.

### BACKGROUND TO THE INVENTION

Additive manufacturing systems utilizing Fused Filament Fabrication (FFF) technology, also known as Fused Deposition Modeling (FDM), relies on filament-based feedstocks. These systems benefit from a high level of standardization due to interchangeable filament spools that have been widely adopted across the industry. However, these methods face limitations when scaled up for larger applications due to high material costs and limited options in large diameter filament. These shortfalls are made more acute by proprietary-only offerings that lock users into single-vendor ecosystems, limiting the wide-spread adoption of LFAM applications.

Fused Granular Fabrication (FGF) offers a cost-effective alternative to filament-based systems by using bulk pellets, which reduce raw-material costs and expand the range of printable materials. However, current FGF systems lack standardized feedstock management, relying instead on ad-hoc integration of external vacuum pumps for pellet conveyance, increasing operational complexity and factory footprint. Additionally, pellets are typically stored in large, open containers, causing them to rapidly absorb ambient moisture-far more so than filament, which is generally stored in vacuum-sealed spools. Moisture trapped in pellets vaporizes during extrusion, creating pores and weakening interlayer adhesion, thus necessitating energy-intensive external drying systems. These hopper-dryer systems must be fully emptied to switch materials, leading to extended downtime during material changeovers.

The present invention addresses these challenges by introducing a fully integrated, compact, and energy-efficient material handling system designed specifically for LFAM applications. By incorporating interchangeable hoppers, inline moisture control, and an integrated vacuum unit coupled with a feedstock metering system, this invention streamlines the entire workflow from pellet storage to extrusion. These integrated components significantly enhance operational efficiency, reduce energy consumption, and enable rapid, tool-free material changeovers, thereby advancing additive manufacturing toward more flexible, on-demand production capabilities.

### SUMMARY OF THE INVENTION

The present invention introduces a novel material handling system specifically designed for large format additive manufacturing setups utilizing FGF technology. The system comprises several innovative components and mechanisms working together to ensure efficient, reliable, and energy efficient transportation of pelletized materials from the feedstock reservoir to the extruder.

### STORAGE AND PREPARATION

An embodiment of the material handling system includes a hopper assembly comprising an interchangeable pellet feedstock reservoir with an integrated desiccant system for passive moisture control. In the preferred embodiment, the pellet reservoir comprises a transparent tube having a diameter of approximately 4 in to 8 in and a height of 3 ft to 6 ft with a perforated desiccant cup designed to permit continuous air exchange with the pellet reservoir, removing moisture from the feedstock. Gaskets between the cup, removable cap, and flanged collar are compressed by external clamps to form an airtight seal, preventing ingress of ambient humidity. When the silica gel within the desiccant cup saturates, the cap is unfastened, the cup is withdrawn and refilled with dry silica gel pellets, then reinserted and resealed.

In other embodiments, the pellet reservoir may take various geometric forms such as rectangular jugs, tapered containers, or custom form-fitting shapes designed to accommodate specific FGF machine layouts and capacity requirements. These alternative hopper assemblies can mount directly onto the machine frame or nest internally, eliminating the need for external storage units and preserving the system's compact footprint.

In another embodiment, moisture control is provided or augmented by an active system incorporating a heated dry-air circuit. Warm air is introduced at the hopper base, flows upward through the pellet feedstock, and exits at an outlet near the hopper's top, forming a closed-loop drying circuit. In a further variation, an inline heater at the hopper inlet precisely regulates air temperature, allowing customizable heat profiles suited to specific material characteristics or process requirements demanding pre-heated or thoroughly dried pellets.

Pellet feedstock is gravity-fed into a metering assembly, separated from the hopper by a butterfly valve, ball valve, or gate valve. This valve connection enables rapid replacement of one hopper with another or facilitates hopper removal for loading different materials. The valve ensures secure containment of pellets during these processes, resuming pellet flow upon reopening and thus minimizing material loss and maintaining cleanliness during material changeovers.

In another embodiment, the hopper assembly incorporates a capacitive sensor that detects low material levels, alerting operators to prevent downtime or printing errors associated with pellet depletion.

Another embodiment envisions future FGF system expansions, introducing modular configurations that incorporate two or more hopper assemblies. Such modular arrangements support diverse operational strategies, including multi-material printing, color printing from differently colored feedstocks, or operational redundancy where multiple reservoirs of the same material ensure continuous system availability and reliability.

Yet another embodiment provides a centralized material supply variant. Individual machine-mounted hopper assemblies receive automatic replenishment from a centralized material handling unit, efficiently managing material distribution across multiple machines arranged in configurations such as print banks. This integrated approach ensures optimal pellet preparation and seamless material transitions, enhancing operational flexibility, efficiency, and overall system adaptability for diverse LFAM environments.

### FEEDSTOCK METERING

An embodiment of the material handling system includes a metering assembly (referred to as the “flow regulator assembly” in the provisional application) positioned directly below the hopper assembly to precisely control pellet flow rate using a controllable actuator. This actuator can adjust speeds both through predefined settings and through real-time operator or autonomous adjustments, ensuring a steady and synchronized pellet supply to match extruder throughput. This precise, just-in-time pellet delivery enables downsizing of conveyance tubes and reduces vacuum air wattage, significantly streamlining the material handling process while maintaining high efficiency.

In the preferred embodiment, the metering assembly comprises a stainless steel spiral auger approximately 1 in to 2 in in diameter, with flights proportionally sized for the specific pellet dimensions. The auger is driven by a compact stepper motor housed within a tubular casing that connects the hopper at one end and the conveyance tube at the other. The assembly supports interchangeable augers with various flight dimensions, accommodating a broad spectrum of pellet sizes (e.g., <1 mm, 1-2 mm, 2-3 mm). For ease of maintenance and cleaning, a portion of the tubular housing can open to facilitate auger interchangeability and reduce material build-up or cross-contamination risks. Optionally, a transparent tube section allows visual inspection and simplifies auger replacement.

In alternative embodiments, the metering assembly may employ various electromechanical actuators, such as a vibrating chute or tube designed to regulate pellet flow; a percussive actuator delivering controlled pellet movement at specified intervals; a linear actuator-based plunger mechanism pushing pellets through a tube; or a metered wheel equipped with tracks or slots dispensing precise pellet volumes with each rotation.

Multiple methods are available for tuning operational parameters-such as speed, direction, and cycle time-to optimize pellet handling. In one embodiment, operators define these parameters via firmware configurations, G-code programming, or pre-established presets, with the additional capability for real-time adjustments through an intuitive graphical user interface. Another embodiment leverages machine learning algorithms to autonomously optimize the metering assembly by continuously analyzing historical operational data. This predictive optimization enhances material flow consistency, energy efficiency, and reliability by proactively preventing jams.

To improve reliability, another embodiment integrates a jam prevention mechanism wherein the auger's rotation direction can be reversed to clear material blockages.

Activation of this feature can occur via software instructions within G-code or machine firmware, manually through the user interface, or automatically through detection of torque anomalies in the motor, thereby reducing downtime and supporting continuous, uninterrupted operation.

### Vacuum Conveyance

In one embodiment of the material handling systems, pellets are conveyed from the metering assembly to the extruder through flexible and pre-formed tube sections. A conductive metal wire is embedded along the length of the tube to dissipate static buildup which can result in the pellets sticking and ultimately jamming the tube. In other embodiments, vibratory or percussive actuators can be positioned at intervals along the length of the tube to improve material flow.

In advanced embodiments, the tube can split into multiple branches allowing the metering assembly to service multiple extruders simultaneously. By incorporating branch tube fittings, such as T-fittings or Y-fittings, along with integrated valve control, the system can also draw feedstock from multiple hoppers and converge on a single extruder, supporting complex printing tasks such as multi-material or color printing.

In the preferred embodiment of the material handling system, pellets are pulled from the metering assembly through a single tubular pathway by a compact vacuum, having a diameter between 3 in to 4 in and delivering 30-50 air watts, directly coupled to the extruder. This design diverges from traditional setups that depend on large external vacuum sources and dual-tube systems-one for material conveyance and another for air return. This on-board vacuum approach localizes air flow management, resulting in a more compact design that optimally utilizes the printer's internal space and lowers operational energy demands.

In one embodiment, the metering device and vacuum system operate independently but are coordinated through a control system. The metering device delivers pellets to a transfer point, such as the mouth of the conveyance tube. The vacuum system activates as needed based on pellet level sensing, enabling asynchronous but logically synchronized pellet delivery.

The vacuum and metering assembly are calibrated and synchronized with the extruder throughput, ensuring a steady stream of pellets is delivered just-in-time. This precise coordination allows for downsizing all components, significantly reducing the system's overall footprint, including smaller conveyance tubing and reduced vacuum wattage. The reservoir can be made exceptionally compact specifically due to the precise synchronization between the onboard vacuum, metering assembly, and extruder, which reduces the need for extensive material buffering. Equipped with a capacitive sensor that monitors material levels, this compact reservoir design minimizes standby material volume, thus decreasing the weight on the printer's moving axes. Consequently, the printer's responsiveness and accuracy are enhanced, while energy consumption is minimized by reducing the mechanical effort required for material handling and motion control.

In one embodiment, the vacuum unit can be housed within a specialized silencer that incorporates sound-deadening material and/or baffles, effectively absorbing and dissipating sound energy generated during operation. The emphasis on minimizing noise pollution not only contributes to a more pleasant user experience but also underscores the system's adaptability to operational settings beyond the factory floor.

### Control System

An embodiment of the material handling system includes a comprehensive control system designed to regulate the integrated process of pelletized material handling within large-format additive manufacturing (LFAM) systems. This control system coordinates critical components, including the metering assembly and onboard vacuum assembly, relative to machine feed rates and extruder throughput, ensuring optimal efficiency, precision, and reliability.

One embodiment includes an explicit programming layer, where instructions such as G-code define operational parameters like auger speed and vacuum rate.

In the preferred embodiment, the system incorporates an additional event-based control layer employing conditional logic within the machine's firmware. Sensor inputs, such as capacitive material level sensors, trigger predefined firmware macros, enabling real-time responses such as alerting operators, activating material feed systems, or adjusting operational parameters dynamically.

Further embodiments introduce a dynamic control layer accessible both to human operators and autonomous systems via a well-defined API. This allows operational adjustments through a graphical user interface or automated interventions driven by AI and machine learning algorithms. These algorithms analyze historical operational data to autonomously refine the system's settings, continuously enhancing material flow, energy efficiency, and reliability.

In an additional embodiment, the control system includes a network layer integrating industrial communication protocols such as Modbus, Ethernet I/P, and IoT protocols like MQTT. This network connectivity enables real-time sensor data exchange and remote operational adjustments, facilitating predictive maintenance, operational analytics, and seamless integration within interconnected manufacturing environments.

Collectively, these control system embodiments provide predictability and repeatability through explicit programming, responsiveness through event-based triggers, direct operational control for human operators, enhanced flexibility through network integration, and continuous optimization via AI-driven feedback.

### BRIEF DESCRIPTION OF THE SEVERAL VIEWS OF THE DRAWING

FIG. 1 illustrates the Hopper Assembly, showcasing the initial component of the material handling system where pelletized materials are stored before being fed into the LFAM process.

FIG. 2 details the Metering Assembly, highlighting the mechanism responsible for precisely controlling the rate at which materials are delivered from the hopper to the extrusion head.

FIG. 3 displays various configurations of the conveyance system, illustrating the versatility and adaptability of the system in transporting materials through different paths and mechanisms based on operational needs.

FIG. 4 reveals the On-board Vacuum Assembly, highlighting the system's integrated design that eliminates the necessity for external vacuum or compressor units. This streamlines both the setup and operations of the LFAM system, significantly simplifying the overall process.

FIG. 5 portrays a representative LFAM system with the present invention seamlessly integrated, demonstrating how the invention fits within and enhances the overall additive manufacturing process.

FIG. 6 presents a flow chart of the control system's modular, layered architecture, delineating how the system intelligently manages material handling through a series of interconnected control strategies, from basic programming to sophisticated machine learning enhancements.

### DETAILED DESCRIPTION OF THE INVENTION

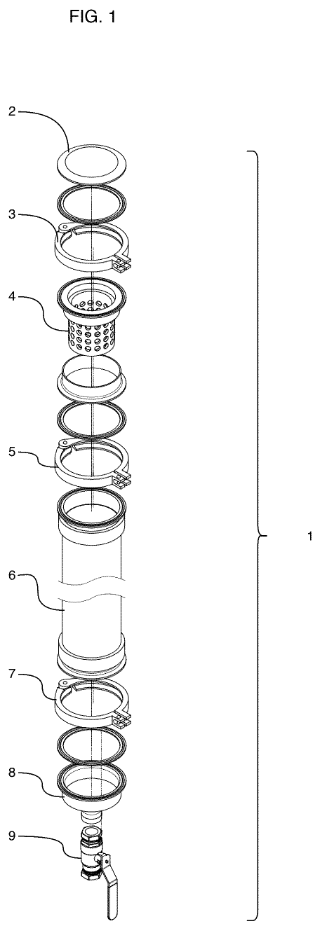

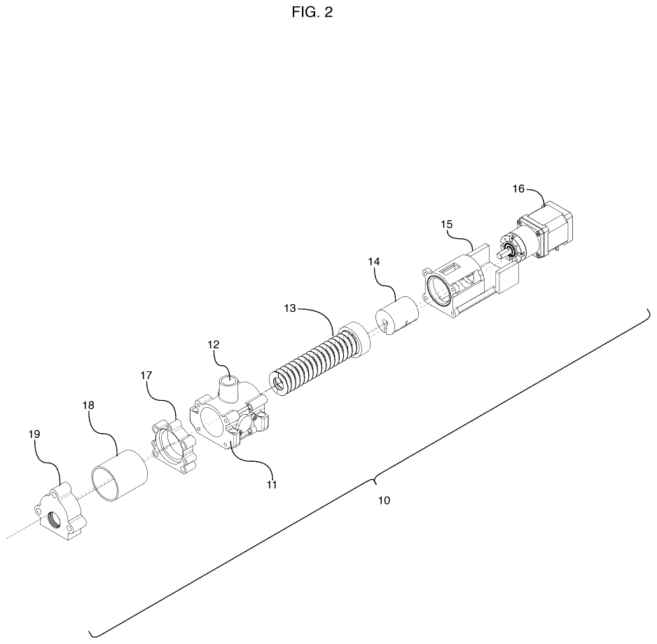

One embodiment of the hopper assembly 1, as illustrated in FIG. 1, comprises a desiccant cup holder 4 for passive moisture control. The desiccant cup can be removed by loosening the upper clamp 3 and removing the top cover 2. To load pellet material, the desiccant cup holder is removed by loosening the lower clamp 5 and filling the hopper tube 6. In an alternative configuration, components 1 through 4 can be substituted with a fitting that connects to a centralized material handling system, which is then secured in place by tightening the lower clamp. A funnel 8 is secured in place by a bottom clamp 7 and leads to a butterfly valve 9. Opening this valve allows the pellets to gravity-feed directly into the metering assembly 10. By closing this valve, the hopper can be disconnected and exchanged with another hopper.

The metering assembly 10, as depicted in FIG. 2, is comprised of an interface chamber 11 having an inlet 12 connected to the hopper assembly 1. In one embodiment, a spiraled auger 13 is connected by a shaft coupling 14 to a motor 16 seated within a tubular housing 15. By unscrewing the tubular housing, components 13 through 16 can be removed and the auger replaced by loosening the set screw in the shaft coupling. A mounting plate 17 and end bracket 19 secure a transparent tube section 18 used to visually monitor pellet flow.

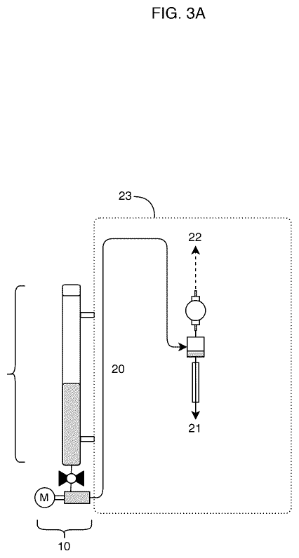

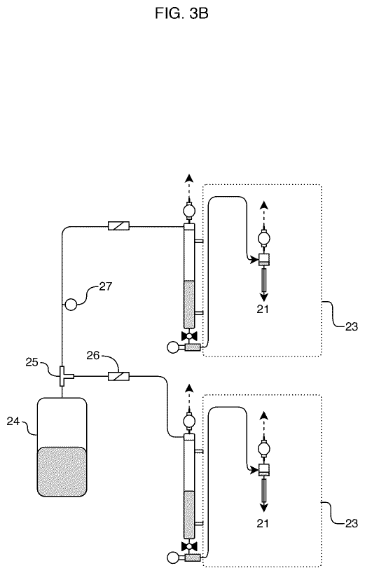

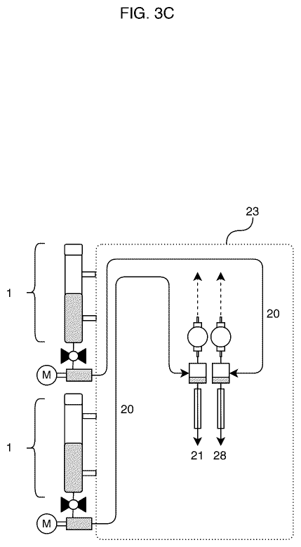

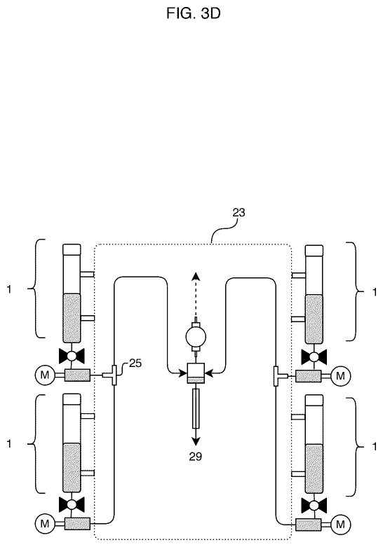

The conveyance tube 20 extending from the metering assembly 10, is illustrated in its baseline configuration in FIG. 3A and consists of both pre-formed and flexible tubing.

The conveyance tube proceeds into the build chamber 23, connecting to the vacuum. The vacuum draws air through the conveyance tube 20, expelling return air 22 into the build chamber, while directing pellets towards the extruder 21. This setup demonstrates a modular, kit-of-parts approach, allowing for reconfiguration to accommodate more complex FGF systems as depicted in subsequent figures.

FIG. 3B depicts an embodiment where two or more FGF machines are linked to a centralized feedstock supply 24 through an expanded conveyance system. Strategically placed T-fittings 25 and actuated valves 26 enable the creation of a multi-branch network, facilitating automatic replenishment of individual machine hoppers. To prevent material jams due to the increased tubing length, vibrators or knockers 27 may be integrated at intervals along the conveyance path. This configuration efficiently networks multiple machines into a highly autonomous printer bank.

An embodiment with dual-extruders, as illustrated in FIG. 3C, comprises distinct conveyance systems connected to a pair of material hoppers to facilitate the printing of primary 21 and support materials 28. This configuration enhances the creation of intricate structures with complex overhangs, bridges, and roofing features by alternating material types.

An embodiment with multi-material feed configuration, as depicted in FIG. 3D, comprises several branches which feed into a single extruder. By precisely controlling the influx of pellets from each branch, this setup capitalizes on FGF technology's capabilities for color mixing and composite material printing 29, expanding the possibilities for additive manufacturing projects.

The vacuum assembly 30, as illustrated in FIG. 4, includes a compact vacuum unit 32 designed to efficiently draw pellets through the conveyance tube 35. The tube fitting 36 precisely directs pellets into the compact reservoir 37, which features an integrated capacitive sensor 38 for monitoring material levels, signaling when replenishment is needed. An optional transparent section 34 allows for visual monitoring of the reservoir's state, enhancing operational oversight. Pellets are smoothly gravity-fed towards the extruder in direction 39, ensuring a consistent supply. Encased within a silencer block 33, the vacuum unit employs sound-deadening materials to minimize operational noise, complemented by a housing element 31 that further aids in acoustic control while providing a sleek, aesthetic finish. This integrated approach not only streamlines pellet conveyance but also prioritizes a quiet, user-friendly operational environment.

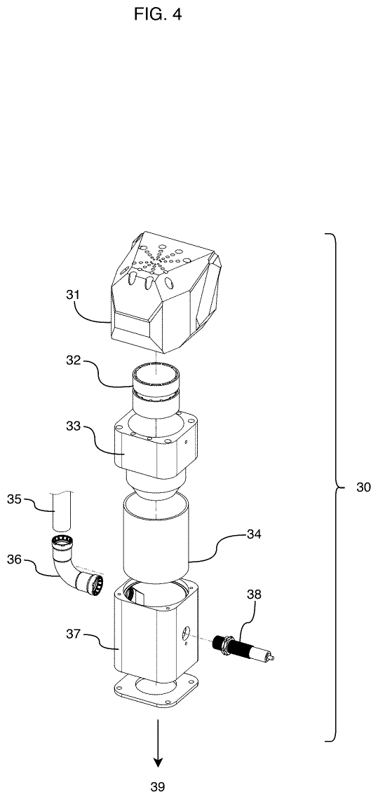

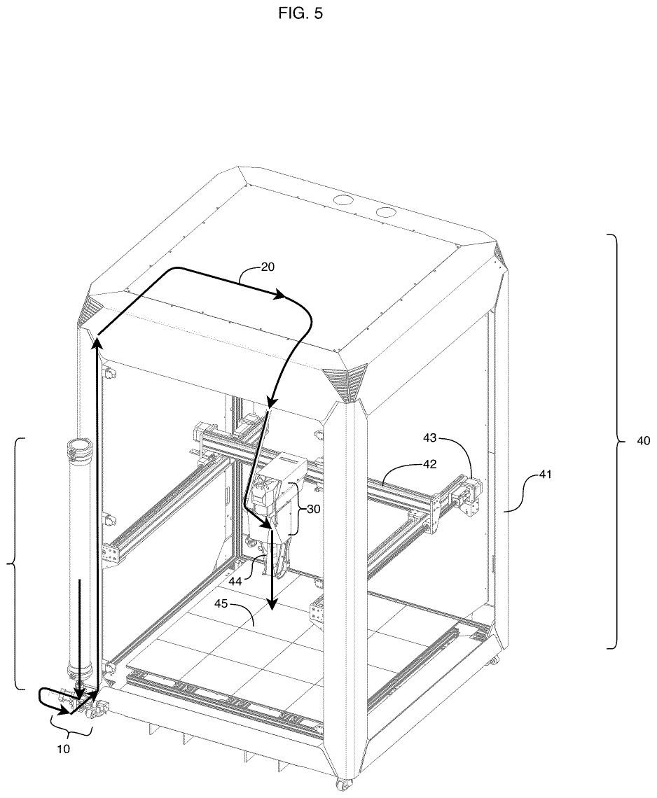

A representative LFAM machine 40 with the Integrated Material Handling System is depicted in FIG. 5 Pellets are gravity-fed from the hopper assembly 1 to the metering assembly 10 then mechanically conveyed to an outlet connecting to the conveyance assembly 20. Pellets travel through the conveyance tube into the build chamber 41. An extruder 44 moves through the build chamber along several linear rails 42 controlled by stepper motors 43. The conveyance tube terminates at the vacuum assembly 30 connected to the extruder. Pellets are directed into the extruder where they are melted and deposited onto the print bed 44.

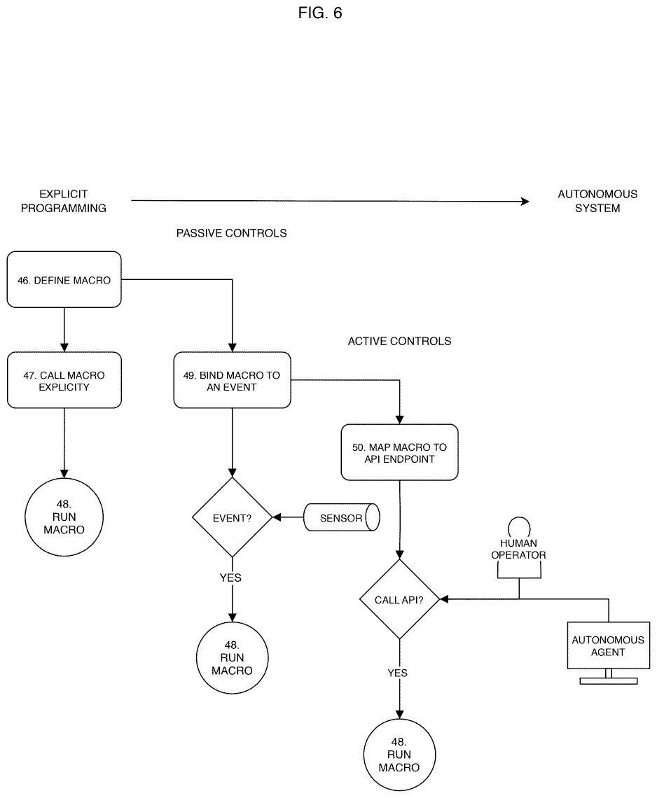

The layered control system is abstracted in FIG. 6. In the first layer, macros are established within the system's programming (G-code or machine code) or firmware configuration file 46. Through explicit programming, a macro is activated by a G-code instruction 47, prompting the firmware to execute the routine 48. This foundational layer ensures predictability and repeatability. A passive control layer responds to conditions like material levels through event-based programming 49. For instance, a sensor-triggered event can automatically execute a vacuum activation macro, enabling the system to adjust to changes without manual input. The introduction of an active control layer 50 further enhances the system's flexibility. Here, macros are accessible via an API endpoint, allowing for real-time adjustments by either human operators or autonomous agents. This layer broadens the system's capacity for adaptive responses beyond predefined scenarios. This flowchart succinctly encapsulates the system's progression from straightforward programmability to an advanced, interactive framework, showcasing its capability to dynamically adjust to the operational environment.

### Conclusion

The disclosed embodiments, culminating in a highly integrated and self-contained system, introduce an advanced approach to material handling in large format additive manufacturing. The integration of these systems offers significant advantages over traditional filament-based and external pellet handling systems, encompassing economic and operational efficiencies, material diversity, compact design, and energy conservation. The key benefits are summarized as follows:

Economic Efficiency: By leveraging pelletized materials, the system not only broadens the range of usable materials but also significantly reduces material costs. Pellets offer a more cost-effective and diverse material base compared to standard filament options.

Operational Efficiency: The fully integrated material handling system streamlines the entire process from storage to extrusion. This integration minimizes downtime and enhances print reliability. The optimized design eliminates the need for an output hose, reducing material losses and enabling the use of a smaller vacuum system for pellet transport, further contributing to operational efficiency.

Material Diversity: The ability to use a wider array of materials, including composite materials that lack the ductility required for filament production, vastly expands the applications and capabilities of LFAM systems.

Compact Design: The system's integration with LFAM systems not only saves valuable space but also simplifies the setup process. Its spatially compact design is especially beneficial in environments where space is at a premium.

Energy Efficiency: A focus on minimizing energy consumption has been central to the system's design. This not only reduces the environmental impact but also lowers operational costs, making large format additive manufacturing more sustainable and economical.

This invention addresses a critical bottleneck in FGF systems: the compact and efficient movement of pelletized materials, a challenge that has historically limited the adoption of FGF due to the comparative simplicity and widespread use of filament-based systems at smaller scales. By addressing the nuanced challenges of material handling within LFAM, the present invention will unlock new applications with its combination of efficiency, versatility, and cost-effectiveness. Through its integrated design and sophisticated control system, the invention makes LFAM more accessible, reliable, and economically viable, thereby marking a significant advancement in the domain and broadening FGF's utility across various sectors.

1. An integrated material handling system for fused granular fabrication (FGF), comprising:
a modular hopper configured to store pelletized feedstock;
a metering device positioned downstream of the hopper and configured to regulate feedstock delivery;
a vacuum conveyance system operatively coupled between the metering device and extruder;
wherein the metering device is synchronized with extruder throughput, and wherein the integration of the hopper, metering device, and vacuum conveyance system enables compact, energy-efficient transport of pelletized material from storage to extrusion.

2. The system of claim 1, further comprising a control system configured to adjust the rate of the metering device in response to changes in extruder throughput.

3. The system of claim 2, wherein the control system enables just-in-time pellet delivery to minimize standby material at the extruder.

4. The system of claim 1, wherein the metering device and vacuum system operate independently and are coordinated through a control system to ensure continuous pellet delivery.

5. The system of claim 1, wherein the vacuum unit is mounted on the same axis as the extruder and moves in tandem with it.

6. The system of claim 1, wherein the hopper comprises a passive moisture control system including a perforated desiccant cup with a gasket-sealed removable cap 7. The system of claim 1, wherein the hopper includes an active moisture control system comprising a heated dry-air loop.

8. The system of claim 1, wherein the vacuum conveyance system includes a compact reservoir equipped with a capacitive level sensor.

9. The system of claim 1, wherein the metering device comprises a stepper-motor-driven auger with interchangeable flight geometries for accommodating multiple pellet sizes.

10. The system of claim 1, wherein the vacuum conveyance system comprises pre-formed or flexible tubing and includes static dissipation elements, vibratory actuators, or percussive actuators to maintain consistent pellet flow.

11. The system of claim 1, wherein the system contains two or more hopper assemblies.

12. The system of claim 11, wherein each hopper contains a different material type or color to enable multi-material or color printing.

13. The system of claim 1, further comprising a conveyance network configured to distribute pelletized feedstock to two or more extruders.

14. The system of claim 13, wherein the conveyance network includes one or more branch fittings and actuated valves for selectively routing pellet flow.

15. The system of claim 1, wherein a centralized material supply unit is configured to automatically replenish a plurality of machine-mounted hopper assemblies.

16. The system of claim 1, wherein the system is configured to deliver pelletized feedstock from multiple hoppers to a single extruder to enable real-time material mixing.
